(19) United States
(12) Patent Application Publication
(10) Pub. No.: US 2021/0312341 A1
(43) Pub. Date: Oct. 7, 2021

(54) INFORMATION PROVIDING APPARATUS, INFORMATION PROVIDING SYSTEM, NON-TRANSITORY COMPUTER-READABLE MEDIUM, AND INFORMATION PROVIDING METHOD

(71) Applicant: TOYOTA JIDOSHA KABUSHIKI KAISHA, Toyota-shi (JP)

(72) Inventors: Minoru KUBOTA, Toyota-shi (JP); Hideo HASEGAWA, Nagoya-shi (JP); Kentaro TAKAHASHI, Toyota-shi (JP); Yusuke KOBAYASHI, Ota-ku (JP); Takashi HORIGUCHI, Toyota-shi (JP); Chikage KUBO, Chofu-shi (JP)

(73) Assignee: TOYOTA JIDOSHA KABUSHIKI KAISHA, Toyota-shi (JP)

(21) Appl. No.: 17/213,928

(22) Filed: Mar. 26, 2021

(30) Foreign Application Priority Data
Apr. 2, 2020 (JP) 2020-066866

(51) Int. Cl. G06Q 10/02; G06Q 10/06; G06Q 50/30

(52) U.S. Cl. CPC G06Q 10/02; G06Q 50/30; G06Q 10/063114

(57) ABSTRACT

The information providing apparatus includes a controller configured to: acquire information that indicates a first point at which a reserving party, who is a user who is to reserve a vehicle operated within a geographical range that includes a plurality of regions, desires to board the vehicle, and information that indicates a second point at which the reserving party desires to alight the vehicle; obtain, based on a service route evaluation result obtained for a service route of the vehicle per combination of a first region including a departure point of the service route and a second region including an arrival point of the service route, among the plurality of regions, an evaluation value for a travel route along which the reserving party is to travel using the vehicle from the first point to the second point; and provide the obtained evaluation value to the reserving party.

### CROSS-REFERENCE TO RELATED APPLICATION

This application claims priority to Japan Patent Application No. 2020-066866, filed Apr. 2, 2020, the entire disclosure of which is incorporated herein by reference.

### TECHNICAL FIELD

The present disclosure relates to an information providing apparatus, an information providing system, an information providing program, and an information providing method.

### BACKGROUND

Patent Document (PTL) 1 describes technology for managing the manners of a user of transportation, which provides a service based on whether the user is ill-mannered or well-mannered, determined in accordance with the surrounding conditions.

### CITATION LIST

### Patent Literature

PTL 1: JP 2015-108854 A

### SUMMARY

According to the technology described in PTL 1, a user who intends to use a vehicle cannot learn of an evaluation value for a service route of the vehicle.

It would be helpful to enable a user who intends to use a vehicle to learn of an evaluation value of a service route of the vehicle.

An information providing apparatus according to an embodiment disclosed herein includes a controller configured to:

acquire first point information and second point information, the first point information indicating a point at which a reserving party, who is a user who is to reserve a vehicle to be operated within a geographical range that includes a plurality of regions, desires to board the vehicle, the second point information indicating a point at which the reserving party desires to alight the vehicle;

obtain, based on a service route evaluation result obtained as a result of having evaluated a service route of the vehicle per combination of a first region and a second region among the plurality of regions, the first region including a departure point of the service route, the second region including an arrival point of the service route, an evaluation value for a travel route along which the reserving party is to travel using the vehicle from the first point indicated by the first point information to the second point indicated by the second point information; and provide the obtained evaluation value to the reserving party.

An information providing program according to an embodiment disclosed herein is configured to cause a computer to execute operations. The operations include:

acquiring first point information and second point information, the first point information indicating a point at which a reserving party, who is a user who is to reserve a vehicle to be operated within a geographical range that includes a plurality of regions, desires to board the vehicle, the second point information indicating a point at which the reserving party desires to alight the vehicle;

obtaining, based on a service route evaluation result obtained as a result of having evaluated a service route of the vehicle per combination of a first region and a second region among the plurality of regions, the first region including a departure point of the service route, the second region including an arrival point of the service route, an evaluation value for a travel route along which the reserving party is to travel using the vehicle from the first point indicated by the first point information to the second point indicated by the second point information; and transmitting the obtained evaluation value to a terminal apparatus of the reserving party.

An information providing method according to an embodiment disclosed herein includes:

acquiring, by an information providing apparatus, first point information and second point information, the first point information indicating the point at which a reserving party, who is a user who is to reserve a vehicle to be operated within a geographical range that includes a plurality of regions, desires to board the vehicle, the second point information indicating the point at which the reserving party desires to alight the vehicle;

obtaining, by the information providing apparatus, based on a service route evaluation result obtained as a result of having evaluated a service route of the vehicle per combination of a first region and a second region among the plurality of regions, the first region including a departure point of the service route, the second region including an arrival point of the service route, an evaluation value for a travel route along which the reserving party is to travel using the vehicle from the first point indicated by the first point information to the second point indicated by the second point information; and transmitting, by the information providing apparatus, the obtained evaluation value to a terminal apparatus of the reserving party.

The present disclosure enables a user who intends to reserve a vehicle to learn of an evaluation value for a service route of the vehicle.

### BRIEF DESCRIPTION OF THE DRAWINGS

In the accompanying drawings:

FIG. 1 is a diagram illustrating a configuration of an information providing system according to an embodiment of the present disclosure;

FIG. 2 is a block diagram illustrating a configuration of an information providing apparatus according to an embodiment of the present disclosure;

FIG. 3 is a block diagram illustrating a configuration of a terminal apparatus according to an embodiment of the present disclosure;

FIG. 4 is a schematic diagram illustrating a plurality of regions and examples of routes of a vehicle to be operated in the plurality of regions, according to an embodiment of the present disclosure;

FIG. 5 is a diagram illustrating an example of a table that stores the service route evaluation result according to an embodiment of the present disclosure; and

FIG. 6 is a diagram illustrating an operation of the information providing system according to an embodiment of the present disclosure.

### DETAILED DESCRIPTION

An embodiment of the present disclosure will be explained below with reference to the drawings.

In the drawings, the same or corresponding portions are denoted by the same reference numerals. In the descriptions of the embodiment disclosed herein, detailed descriptions of the same or corresponding portions are appropriately omitted or simplified.

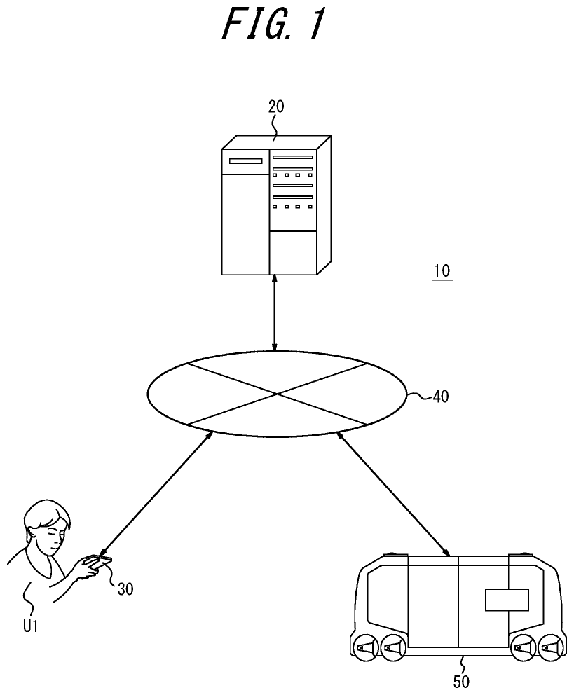

A configuration of the information providing system 10 according to the present embodiment will be described with reference to FIG. 1.

The information providing system 10 according to the present embodiment includes at least one information providing apparatus 20, a terminal apparatus 30 of a user U1, and at least one vehicle 50.

The information providing apparatus 20 can communicate with the terminal apparatus 30 via a network 40.

The network 40 includes the Internet, at least one WAN, at least one MAN, or a combination thereof. “WAN” is an abbreviation of wide area network. “MAN” is an abbreviation of metropolitan area network. The network 40 may include at least one wireless network, at least one optical network, or a combination thereof. Examples of the wireless network include an ad hoc network, a cellular network, a wireless LAN, a satellite communication network, and a terrestrial microwave network. “LAN” is an abbreviation of local area network.

The information providing apparatus 20 is installed in a facility such as a data center. The information providing apparatus 20 is a server which belongs to a cloud computing system or other computing systems.

In the present embodiment, the terminal apparatus 30 is configured as a user terminal possessed by the user U1. Examples of the terminal apparatus 30 include a mobile apparatus such as a mobile phone, a smartphone or a tablet, and a PC. “PC” is an abbreviation of personal computer.

The vehicle 50 is an on-demand bus in this embodiment, but may be another type of on-demand vehicle, such as a ride-sharing taxi. The vehicle 50 may be any type of vehicle, such as, for example, a gasoline vehicle, diesel vehicle, HV, PHV, EV, and FCV. “HV” is an abbreviation of hybrid vehicle. “PHV” is an abbreviation of Plug-in Hybrid Vehicle. “EV” is an abbreviation of Electric Vehicle. “FCV” is an abbreviation of Fuel Cell Vehicle. In the present embodiment, the operation of the vehicle 50 is automated at an arbitrary level, but may be driven by a driver. The level of automation of the operation of the vehicle 50 is, for example, any of Level 1 to Level 5 according to the classification of the SAE. “SAE” is an abbreviation of Society of Automotive Engineers. The vehicle 50 may be a multi-purpose autonomous driving EV for MaaS. “MaaS” is an abbreviation of Mobility as a Service.

The vehicle 50 is available for ride-sharing in the present embodiment and can carry a large number of unspecified users, but may carry only one user or a small number of specified users.

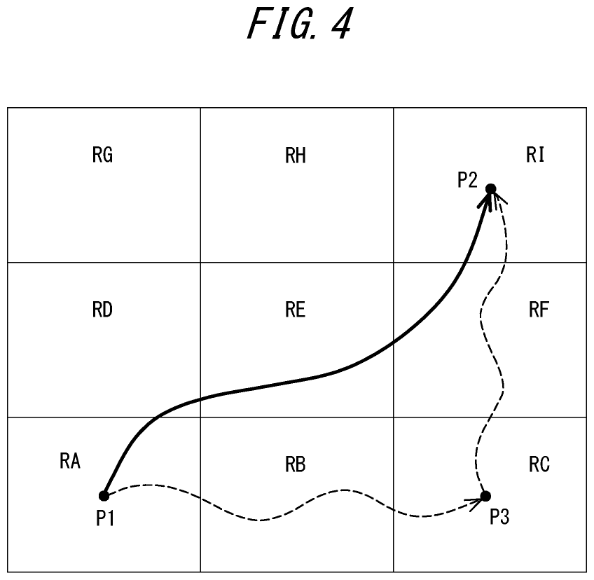

An outline of the present embodiment will be described with reference to FIGS. 1 and 4.

In the information providing system 10 according to the present embodiment, the terminal apparatus 30 of a reserving party, who is the user U1 who is to reserve the vehicle 50 operated within a geographical range that includes a plurality of regions, accepts an operation made by the reserving party for inputting a first point P1, which is a point at which the reserving party desires to board the vehicle 50, and a second point P2, which is a point at which the reserving party desires to alight the vehicle 50. The information providing apparatus 20 receives, from the terminal apparatus 30, first point information indicating the first point P1 and second point information indicating the second point P2. The information providing apparatus 20 obtains, based on service route evaluation results 60 obtained as a result of having evaluated a service route of the vehicle 50 per combination of a first region and a second region among the plurality of regions, the first region including a departure point of the service route, the second region including an arrival point of the service route, an evaluation value for a travel route along which the user U1 travels using the vehicle 50 from the first point P1 indicated by the first point information to the second point P2 indicated by the second point information. The information providing apparatus 20 transmits information indicating the obtained evaluation value to the terminal apparatus 30.

According to the present embodiment, the reserving party, who is the user U1 who is to reserve the vehicle 50, can learn of the evaluation value for a service route of the vehicle 50.

Further, in the information providing system 10 according to the present embodiment, the information providing apparatus 20 includes, in the service route evaluation results 60, an evaluation made by an evaluator as a user U2 who was on board the vehicle 50, of another user who was also on board the vehicle 50.

According to the present embodiment, the reserving party who is the user U1 who is to reserve the vehicle 50 can learn of the quality of s another user who was on board the vehicle 50.

With reference to FIG. 4, a geographical range including a plurality of regions and a route of the vehicle 50 that is operated within the geographical range according to the present embodiment will be described.

In the present embodiment, the “plurality of regions” are defined by dividing a geographical range in which the vehicle 50 can be operated. The geographical range in which the vehicle 50 can be operated may be arbitrarily determined; however, the geographical range may be, for example, a range in which the vehicle 50 can circulate within a certain time period.

The plurality of regions include, for example, a plurality of adjacent regions RA to RI arranged in a 3×3 matrix as illustrated in FIG. 4. In the present embodiment, the number of regions is 9, but the number may be any number without being limited thereto. The shape of each of the regions is rectangular but this is not limiting and they may be any shape.

In the present embodiment, the “service route” is a route along which the vehicle 50 was operated within the geographical range. The geographical range includes one or more service routes. The service routes may include not only a route that has a departure point and an arrival point in different regions, but also a route that has both the departure point and the arrival point in the same region.

In the present embodiment, the “travel route” is a route along which the vehicle 50 is to travel from the first point P1 indicated by the first point information to the second point P2 indicated by the second point information. The “service route” refers to a driving route along which the vehicle 50 has already been operated. Meanwhile, the “travel route” refers to a route along which the vehicle 50 is to travel from the first point P1 that is the point at which the reserving party, who is the user U1 who is to reserve the vehicle 50, desires to board the vehicle 50, to the second point P2 that is the point at which the reserving party desires to alight the vehicle 50.

The “service route evaluation results” are obtained as a result of having evaluated a service route of the vehicle 50 per combination of a first region and a second region among the plurality of regions, the first region including a departure point of the service route, the second region including an arrival point of the service route. In the present embodiment, the service route evaluation results 60 are calculated by analyzing, by any method, results obtained through individual evaluations for each service route of the vehicle 50 within the plurality of regions. An exemplary method for analyzing the results includes a method of aggregating results obtained by individually evaluating each service route to obtain the summary statistics such as an average value or a standard deviation therefor.

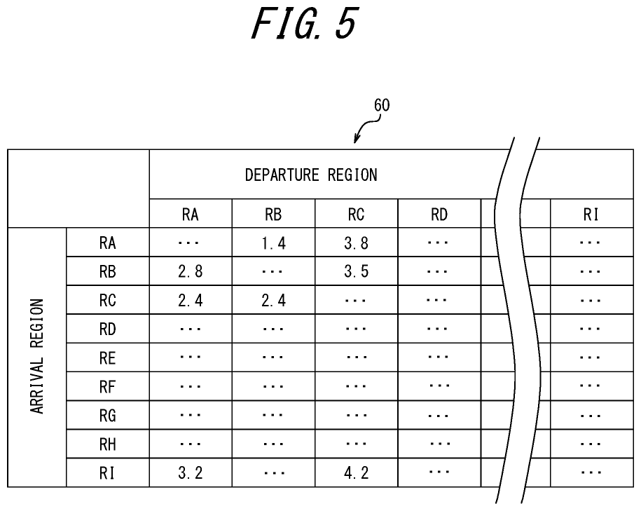

In this embodiment, the evaluation for each service route may be made by any method; for example, the method described in Patent Document 1 can be used. A specific evaluation method in the present embodiment will be described later. The “service route evaluation results”, which may be stored in any form, are stored in a database. Specifically, the “service route evaluation results” are stored in the table illustrated in FIG. 5 in the present embodiment. The table of FIG. 5 stores, as a result of the evaluation made for each service route of the vehicle 50, a statistical value such as, for example, an average value, per combination of the first region and the second region among the plurality of regions, the first region including a departure point of each service route of the vehicle 50, the second region including an arrival point of each service route of the vehicle 50.

For example, provided that the departure point of a certain service route is included in the region RA and the arrival point of the service route is included in the region RB, the evaluation for the service route is calculated for the combination of the region RA as the departure region and the region RB as the arrival region. When a plurality of service routes are found for the same combination, the summary statistics obtained for the evaluation for the plurality of service routes may be calculated as the evaluation value for the combination. The table of FIG. 5 indicates 2.8 [points] as the evaluation value for the combination of the region RA as the departure region and the region RB as the arrival region of the service route of the vehicle 50. In the disclosed embodiment, the evaluation for each service route is calculated as a score, but the present invention is not limited thereto. The evaluation for a service route may be calculated by any method, for example, by means of a scale evaluation or an evaluation function.

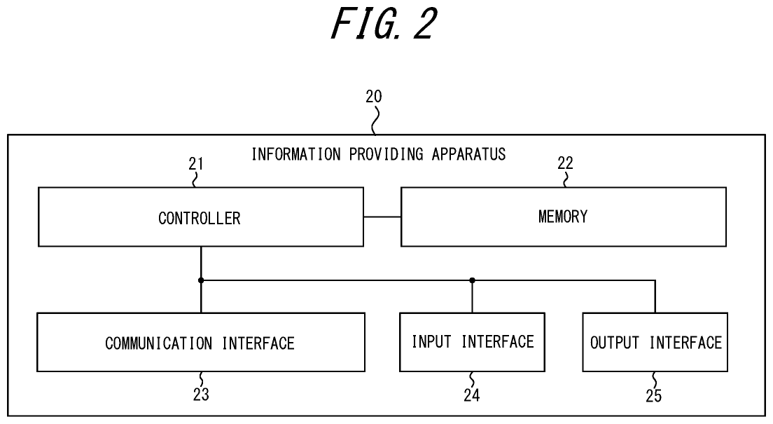

The configuration of the information providing apparatus 20 according to the disclosed embodiment will be described with reference to FIG. 2.

In the disclosed embodiment, the information providing apparatus 20 is configured as a server.

The information providing apparatus 20 includes a controller 21, a memory 22, a communication interface 23, an input interface 24, and an output interface 25.

The controller 21 includes at least one processor, at least one dedicated circuit, or a combination thereof. Examples of the processor include a general-purpose processor such as CPU or GPU, and a dedicated processor dedicated to specific processing. “CPU” is an abbreviation of central processing unit. “GPU” is an abbreviation of graphics processing unit. The dedicated circuit is, for example, an FPGA or an ASIC. “FPGA” is an abbreviation of field-programmable gate array. “ASIC” is an abbreviation of application specific integrated circuit. The controller 21 executes processing related to the operation of the information providing apparatus 20 while controlling each unit of the information providing apparatus 20.

The memory 22 includes at least one semiconductor memory, at least one magnetic memory, at least one optical memory, or a combination of at least two of these. Examples of the semiconductor memory include RAM and ROM. “RAM” is an abbreviation of random access memory. “ROM” is an abbreviation of read only memory. Examples of RAM include SRAM and

DRAM. “SRAM” is an abbreviation of static random access memory. “DRAM” is an abbreviation of dynamic random access memory. An examples of ROM is EEPROM. “EEPROM” is an abbreviation of electrically erasable programmable read only memory. The memory 22 functions as, for example, a main memory, an auxiliary memory, or a cache memory. The memory 22 stores information for use in operation of the information providing apparatus 20 and information resulting from operations of the information providing apparatus 20. In the disclosed embodiment, the table of FIG. 5 is stored in the memory 22, but may be stored in an external storage apparatus or the like.

The communication interface 23 includes at least one interface for communication. An example of the interface for communication is a LAN interface. The communication interface 23 receives information for use in operations of the information providing apparatus 20, or transmits information resulting from operations of the information providing apparatus 20.

The input interface 24 includes at least one interface for input.

Examples of the interface for input include a physical key, a capacitive key, a pointing device, a touch screen integrally provided with a display, or a microphone. The input interface 24 receives a manipulation for inputting information for use in operations of the information providing apparatus 20. The input interface 24 may be connected to the information providing apparatus 20 as external input equipment, instead of being provided to the information providing apparatus 20. The connection may be established through any communication method such as USB, HDMI® (HDMI is a registered trademark in Japan, other countries, or both), or Bluetooth® (Bluetooth is a registered trademark in Japan, other countries, or both). “USB” is an abbreviation of Universal Serial Bus. HDMI® is an abbreviation of

High-Definition Multimedia Interface.

The output interface 25 includes at least one interface for output. Examples of the interface for output include a display and a speaker. Examples of the display include an LCD and an organic EL display. “LCD” is an abbreviation of liquid crystal display. “EL” is an abbreviation of electro luminescent. The output interface 25 outputs information resulting from operations of the information providing apparatus 20. The output interface 25 may be connected to the information providing apparatus 20 as external output equipment instead of being provided to the information providing apparatus 20. The connection may be established through any communication method such as USB, HDMI®, or Bluetooth®.

Functions of the information providing apparatus 20 are implemented by execution of the information providing program according to the disclosed embodiment, by a processor corresponding to the controller 21. In other words, functions of the information providing apparatus 20 are implemented by software. The information providing program causes a computer to execute the operations of the information providing apparatus 20, to thereby cause the computer to function as the information providing apparatus 20. That is, the computer executes operations of the information providing apparatus 20 according to the information providing program, to thereby function as the information providing apparatus 20.

The program may be stored in a non-temporary, computer-readable medium. Examples of the non-transitory computer-readable medium include a magnetic storage device, an optical disc, a magneto-optical storage device, and a semiconductor memory. The program is distributed by sale, transfer of ownership, or rental of a portable recording medium such as a DVD or a CD-ROM on which the program is recorded. “DVD” is an abbreviation of digital versatile disc. “CD-ROM” is an abbreviation of compact disc read only memory. The program may be stored in storage in a server and distributed by transferring the program from the server to another computer. The program may be provided as a program product.

The computer temporarily stores in a main storage device, for example, a program stored in a portable recording medium or a program transferred from a server. The computer then reads out the program stored in the main storage device using a processor, and executes processing according to the program thus read out. The computer may read a program directly from the portable recording medium, and execute processing according to the program. Each time a program is transferred from the server to the computer, the computer may sequentially execute processing according to the received program. The processing may be executed through a so-called ASP-type service which implements functions merely by execution of instructions and acquisition of results, without transferring the program from the server to the computer. “ASP” is an abbreviation of application service provider. The program includes information for use in processing by an electronic computer, equivalent to a program. For example, data which is not a direct instruction to a computer but has properties that define the processing of the computer is “information equivalent to a program”.

Some or all of the functions of the information providing apparatus 20 may be implemented by a dedicated circuit corresponding to the controller 21. That is, some or all of the functions of the information providing apparatus 20 may be implemented by hardware.

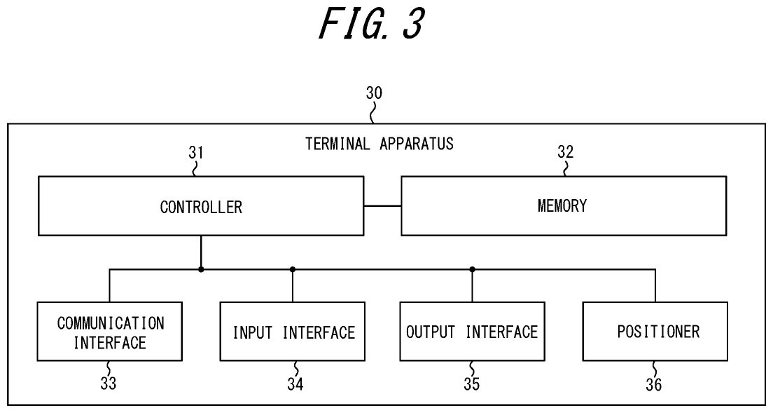

The configuration of the terminal apparatus 30 according to the disclosed embodiment is explained with reference to FIG. 3.

The terminal apparatus 30 includes a controller 31; a memory 32; a communication interface 33; an input interface 34; an output interface 35; and a positioner 36.

The controller 31 includes at least one processor, at least one dedicated circuit, or a combination thereof. Examples of the processor include a general-purpose processor such as a CPU or a GPU, and a dedicated processor dedicated to specific processing. The dedicated circuit is, for example, an FPGA or an ASIC. The controller 31 controls each component of the terminal apparatus 30 to execute processing related to the operations of the terminal apparatus 30.

The memory 32 includes at least one semiconductor memory, at least one magnetic memory, at least one optical memory, or a combination of at least two of these kinds of memories. Examples of the semiconductor memory include RAM and ROM. Examples of RAM include SRAM and DRAM. An example of ROM is EEPROM. The memory 32 functions as, for example, a main memory, an auxiliary memory, or a cache memory. The memory 32 stores information for use in operations of the terminal apparatus 30 and information resulting from operations of the terminal apparatus 30.

The communication interface 33 includes at least one interface for communication. Examples of the interface for communication include an interface conforming to mobile communication standards such as LTE, 4G, or 5G; an interface conforming to near field communication standards such as Bluetooth®; and a LAN interface. “LTE” is an abbreviation of Long Term Evolution. “4G” is an abbreviation of 4th generation. “5G” is an abbreviation of 5th generation. The communication interface 33 receives information for use in operations of the terminal apparatus 30 and transmits information resulting from operations of the terminal apparatus 30.

The input interface 34 includes at least one interface for input.

Examples of the interface for input include a physical key, an electrostatic capacitance key, a pointing device, a touch screen integrally provided with a display, and a microphone. The input interface 34 receives a manipulation input information for use in operations of the terminal apparatus 30. The input interface 34 may be connected to the terminal apparatus 30 as external input equipment, instead of being provided to the terminal apparatus 30. The connection may be established through any communication method such as USB, HDMI®, or Bluetooth®.

The output interface 35 includes at least one interface for output. Examples of the interface for output include a display and a speaker. Examples of the display include an LCD and an organic EL display. The output interface 35 outputs information resulting from operations of the terminal apparatus 30.

The output interface 35 may be connected as external equipment to the terminal apparatus 30, instead of being provided to the terminal apparatus 30. The connection may be established through any communication method such as USB, HDMI®, or Bluetooth®.

The positioner 36 includes at least one GNSS receiver. “GNSS” is an abbreviation of global navigation satellite system. Examples of GNSS include GPS, QZSS, GLONASS, and Galileo. “GPS” is an abbreviation of Global Positioning System. “QZSS” is an abbreviation of Quasi-Zenith Satellite System. The satellites for QZSS are known as quasi-zenith satellites. “GLONASS” is an abbreviation of Global Navigation Satellite System. The positioner 36 measures the position of the terminal apparatus 30.

Functions of the terminal apparatus 30 are implemented by execution of the terminal program according to the disclosed embodiment, by a processor corresponding to the controller 31. In other words, functions of the terminal apparatus 30 are implemented by software. The terminal program causes a computer to execute the operations of the terminal apparatus 30, to thereby cause the computer to function as the terminal apparatus 30. In other words, the computer executes the operations of the terminal apparatus 30 according to the terminal program, to thereby function as the terminal apparatus 30.

Some or all of the functions of the terminal apparatus 30 may be implemented by a dedicated circuit corresponding to the controller 31. That is, some or all of the functions of the terminal apparatus 30 may be implemented by hardware.

The operations of the information providing system 10 according to the disclosed embodiment will be described with reference to FIGS. 4, 5, and 6. These operations correspond to the information providing method according to the disclosed embodiment.

In the disclosed embodiment, a reserving party, who is the user U1 who intends to use the vehicle 50, which is an on-demand bus, makes a reservation for the vehicle 50 via the terminal apparatus 30 of the reserving party. More specifically, the user U1 performs an operation for inputting, to the terminal apparatus 30 of the user U1, the first point P1, which is a point at which the user U1 desires to board the vehicle 50, and the second point P2, which is a point at which the user U1 desires to alight the vehicle 50. The input of the first point P1 and the second point P2 may be performed by an arbitrary procedure. For example, the user U1 inputs the first point P1 and the second point P2 by tapping the first point P1 or the second point P2 on a map displayed on a touch screen corresponding to the input interface 34. The user U1 may input the first point P1 and the second point P2 by voice using a microphone corresponding to the input interface 34. The user U1 may enter the first point P1 and the second point P2 as text using physical keys as the input interface 34.

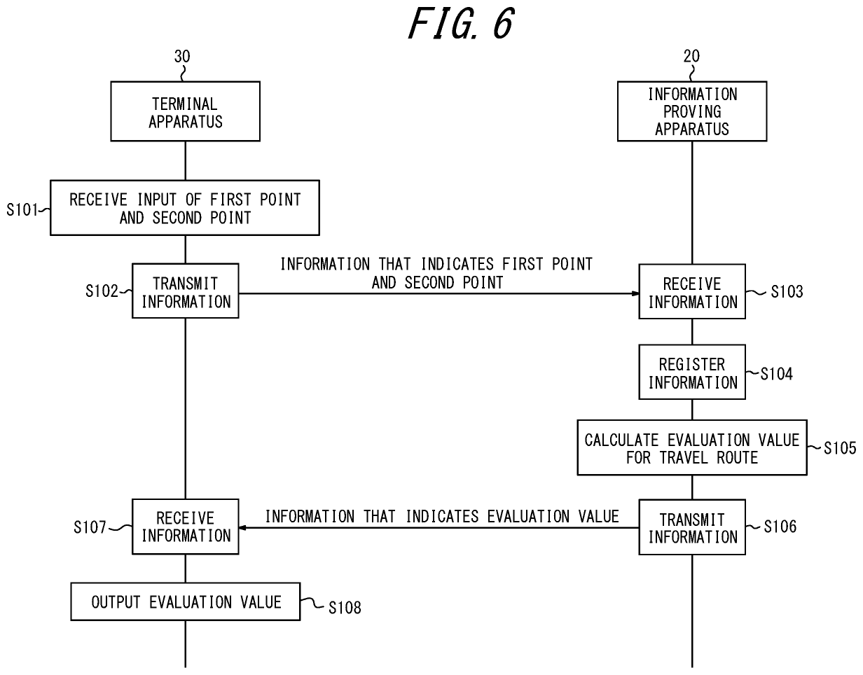

When the first point P1 and the second point P2 are input by the user U1, the controller 31 of the terminal apparatus 30 of the user U1 accepts, in Step S101 of FIG. 6, an operation for inputting the first point P1 and the second point P2 via the input interface 34. The first point P1 is a point at which the user U1 desires to board the vehicle 50. The second point is a point at which the user U1 desires to alight the vehicle 50.

In Step S102, the controller 31 of the terminal apparatus 30 transmits, to the information providing apparatus 20, the information indicating the first point P1 and the second point P2 input in Step S101. Specifically, the controller 31 of the terminal apparatus 30 transmits, to the information providing apparatus 20 via the communication interface 33, the information that indicates the first point P1 and the second point P2 input by the user U1. The information that indicates the first point P1 and the second point P2 includes, for example, position information or names of the first point P1 and the second point P2. The “position information” is, for example, an address, or a two dimensional coordinate, such as a longitude and a latitude, or a three dimensional coordinate.

In Step S103, the controller 21 of the information providing apparatus 20 receives the information transmitted in Step S102. Specifically, the controller 21 of the information providing apparatus 20 receives, via the communication interface 23, information indicating the first point P1 and the second point P2 transmitted from the terminal apparatus 30.

In Step S104, the controller 21 of the information providing apparatus 20 stores, in the memory 22, the information received in Step S103. Specifically, the controller 21 of the information providing apparatus 20 stores, in the memory 22, information indicating the first point P1 and information indicating the second point P2.

In this way, the controller 21 of the information providing apparatus 20 according to the disclosed embodiment acquires the first point information and the second point information, the first point information indicating the first point P1 at which the reserving party, who is the user U1 who is to reserve the vehicle 50, desires to board the vehicle 50, the second point information indicating the second point P2 at which the reserving party desires to alight the vehicle 50, the vehicle 50 being operated within a geographical range including a plurality of regions.

In Step S105, the controller 21 of the information providing apparatus 20 reads out, from the memory 22, the information that indicates the first point P1 and the information that indicates the second point P2 and identifies the first point P1 and the second point P2 based on the read information. The controller 21 obtains an evaluation value for a travel route to be traveled from the first point P1 indicated by the first point information to the second point P2 indicated by the second point information, based on the service route evaluation results 60 obtained as a result of having evaluated a service route of the vehicle 50 per combination a first region and a second region among the plurality of regions, the first region including a departure point of the service route and the second region including an arrival point of the service route. In the disclosed embodiment, the controller 21 can uniquely identify an evaluation value for each combination of the first region and the second region among the plurality of regions, the first region and the second region each including a departure point and an arrival point, respectively, of the service route. In the example of FIG. 4, the first point P1 as the departure point of the travel route is included in the region RA and the second point P2 as the arrival point of the travel route is included in the region RI, and thus the controller 21 refers to the service route evaluation results 60 of FIG. 5, to obtain the evaluation value for the travel route as 3.2 [points], which is the evaluation value identified for the combination of the region RA as the departure region and the region RI as the arrival region.

In Step S106, the controller 21 transmits, to the terminal apparatus 30 via the communication interface 23, information indicating 3.2 [points], which is the evaluation value obtained in Step S105.

In Step S107, the controller 31 of the terminal apparatus 30 receives the information transmitted from the information providing apparatus 20 in Step S106, via the communication interface 33. Specifically, the controller 31 of the terminal apparatus 30 receives, via the communication interface 33, information indicating 3.2 [points] which is the evaluation value transmitted from the information providing apparatus 20. The controller 31 stores, in the memory 32, the received information indicating the evaluation value.

In Step S108, the controller 31 reads out the information stored in the memory 32, and outputs the evaluation value indicated by the read information, to the output interface 35 of the terminal apparatus 30. Specifically, the controller 31 displays 3.2 [points], which is the evaluation value indicated by the received information, on a display corresponding to the output interface 35. The controller 31 may output the evaluation value by voice from a speaker corresponding to the output interface 35.

In this way, the controller 21 of the information providing apparatus 20 provides the obtained evaluation value to the reserving party.

According to the disclosed embodiment, the reserving party, who is the user U1 who is to reserve the vehicle 50, can learn of the evaluation value for a service route of the vehicle 50.

As a modification of the disclosed embodiment, the table that stores the service route evaluation results 60 may store, as the result of having evaluated each service route of the vehicle 50, the results of having individually evaluated each service route per combination of a first region that includes a departure point of the service route of the vehicle 50 and a second region that includes an arrival point of the service route of the vehicle 50, in place of the statistical values such as the average values obtained for each combination of a first region that includes a departure point of each service route of the vehicle 50 and a second region that includes an arrival point of each service route of the vehicle 50. The results of evaluations individually made for each service route stored in the service route evaluation results 60 refers to, for example, one or more scores or scale evaluations that are calculated as the result of evaluations made for one or more service routes whose departure points and arrival points belong to the same combination of the first region and the second region. When the example of FIG. 4 is applied, the controller 21 of the information providing apparatus 20 identifies, in Step S105, the evaluation results obtained for one or more service routes each having the departure point in the region RA which includes the first point P1 as the departure point of the travel route and the arrival point in the region R1 which includes the second point P2 as the arrival point of the travel route, and performs statistical processing such as averaging on the identified evaluation results, to thereby calculate the evaluation value for the travel route.

According to this modification, there is no need to calculate in advance the statistical values for the results of evaluations made for the individual service routes.

As a modification of the disclosed embodiment, the service route evaluation results 60 may include a result of having evaluated each service route for each classification of a plurality of classifications for operating days of the vehicle 50. Specifically, results of evaluations made for service routes of the vehicle 50, for each combination a first region and a second region among the plurality of regions, the first region including a departure point of each service route, the second region including an arrival point of each service route, may be stored in different tables according to the classification of the day on which the vehicle 50 was operated.

In this modification, the plurality of classifications for operating day s include a weekday classification and a weekend classification. In this modification, for convenience, examples of the weekday classification include Monday to Friday, and examples of the weekend classification include Saturday, Sunday, and holidays.

In this case, the controller 21 of the information providing apparatus 20 determines the day on which the user U1 desires to travel from the first point P1 to the second point P2 using the vehicle 50, and identifies the determined day as the travel day. The controller 21 may use any method to determine the day on which the user U1 desires to travel. For example, the controller 21 may determine the day on which the user U1 has input the first point P1 and the second point P2 as the day on which the user U1 desires to travel, or may ask the user U1, via the terminal apparatus 30, what day the user U1 desires to travel, so as to determine the day on which the user U1 desires to travel. The controller 21 identifies the classification of the travel day thus determined. Specifically, the controller 21 identifies whether the travel day falls under the weekday classification or the weekend classification, based on the date or the day of the week of the determined travel day. If the date of the travel day is Mar. 16, 2020, the controller 21 determines that the travel day is Monday, based on, for example, a calendar function provided in advance in the information providing apparatus 20, and identifies that the classification of the travel day is weekday.

In this way, the controller 21 identifies, from among the plurality of classifications, the classification of a certain travel day.

In the Step S105 of FIG. 6, the controller 21 obtains, based on the service route evaluation results 60 corresponding to the identified classification, an evaluation value for a route to be traveled from the first point P1 to the second point P2 by the vehicle 50 on the travel day, as the evaluation value for the travel route. In a case in which the classification is identified as weekday, the controller 21 refers to the result of evaluations made for the service routes of the vehicle 50 operated on weekdays, to obtain an evaluation value for the travel route to travel from the first point P1 to the second point P2 using the vehicle 50 on the travel day.

According to this modification, the reserving party, who is the user U1 who is to reserve the vehicle 50, can learn of the evaluation value of the service route of the vehicle 50 according to the date or day of the week on which the user U1 desires to board the vehicle 50.

In this modification, when the evaluation value for the travel route on a certain travel day is equal to or less than a threshold, the controller 21 further obtains an evaluation value for the travel route on a day included in a different classification, based on the service route evaluation results 60 corresponding to a different classification from the classification of the travel day. For example, provided that the threshold is 4 [points] and the evaluation value obtained for the weekday classification is 3.8 [points], it means that the obtained evaluation value is equal to or less than the threshold, and thus the controller 21 obtains an evaluation value for the service route on a day included in the weekend classification, based on the travel route evaluation results 60 corresponding to the weekend classification.

In Step S106, the controller 21 provides, to the reserving party who is the user U1, an evaluation value for the travel route on a day included in the different classification, in place of the evaluation value for the travel route on the travel day or together with the evaluation value for the travel route on the travel day. Specifically, the controller 21 may notify the user U1 of the evaluation value obtained for the weekend classification, in place of the evaluation value obtained for the weekday classification or together with the evaluation value obtained for the weekday classification.

According to this modification, the user U1 can learn of the evaluation value for the travel route corresponding to a day of the different classification from the classification for the day on which the user U1 desires to board the vehicle 50. Further, the user U1 can compare the evaluation value for the travel route corresponding to the classification of the day on which the user U1 desires to board the vehicle 50, with the evaluation value for the travel route corresponding to the different classification of a day from the classification of the day on which the user U1 desires to board the vehicle 50.

In the aforementioned modification, when the evaluation value obtained for the weekend classification is still equal to or less than the threshold, or when the evaluation value obtained for the weekend classification is equal to or less than the evaluation value obtained for the weekday classification, the controller 21 of the information providing apparatus 20 may notify the user U1 of the evaluation value obtained for the weekday classification, without notifying the user U1 of the evaluation value obtained for the weekend classification.

As a modification of the disclosed embodiment, the service route evaluation results 60 may include a result of an evaluation made for a service route for each of a plurality of segments for the operation time period of the vehicle 50. Specifically, the results of an evaluation made for the service route of the vehicle 50, for each combination of a first region and a second region among the plurality of regions, the first region including a departure point of each of the service routes, the second region including an arrival point of each of the service routes, may be stored in different tables according to the operation time period in which the vehicle 50 was operated.

In this modification, a plurality of segments in the operation time period includes a morning segment and an afternoon segment. In this modification, for convenience, it is assumed that the operation time period of the vehicle 50 is from 9:00 to 22:00, in which the morning segment is from 9:00 to 12:00 and the afternoon segment is from 12:00 to 22:00.

In this case, the controller 21 of the information providing apparatus 20 determines the time slot in which the user U1 desires to travel from the first point P1 to the second point P2 using the vehicle 50, and identifies the determined time slot as the travel time slot. The controller 21 may use any method to determine the time slot in which the user U1 desires to travel. For example, the controller 21 may determine the time slot in which the user U1 has input the first point P1 and the second point P2, as the time slot in which the user U1 desires to travel, or may ask the user U1, via the terminal apparatus 30, what time slot the user desires to travel, so as to determine the time slot in which the user U1 desires to travel. Alternatively, the controller 21 may acquire information indicating the desired boarding time at which the user U1 desires to board the vehicle 50, and determine the travel time slot based on the boarding time and the time needed to travel from the first point P1 to the second point P2. The controller 21 identifies the segment of the determined travel time slot. Specifically, the controller 21 identifies whether the determined travel time slot falls under the morning segment or the afternoon segment. In this example, the controller 21 acquires information indicating the desired boarding time at which the user U1 desires to board the vehicle 50. This example provides that the desired boarding time is 10:00 and the time needed to travel from the first point P1 to the second point P2 is 3 hours. The time needed for the travel may be stored in advance in the memory 32, or may be calculated by the controller 21 based on the distance from the first point P1 to the second point P2. The controller 21 determines that the travel time slot of the reserving party is 10:00 to 13:00, based on the desired boarding time and the time needed for the travel. The travel time slot relates to both the morning segment and the afternoon segment; however, the time period that relates to the morning segment is longer than the time period that relates to the afternoon segment, and thus the controller 21 identifies that the travel time slot is in the morning segment.

In this way, the controller 21 identifies, from among the plurality of segments, the segment of a certain travel time slot.

In the Step S105 of FIG. 6, the controller 21 obtains, as the evaluation value for the travel route, an evaluation value for the travel route in the travel time slot, based on the travel route evaluation results 60 corresponding to the determined segment. If the identified segment is morning, the controller 21 refers to the result of an evaluation made for the service route of the vehicle 50 operated in the morning to obtain the evaluation value for the route to travel from the first point P1 to the second point P2 using the vehicle 50 in the travel time slot.

According to this modification, the reserving party, who is the user U1 who is to reserve the vehicle 50, can learn of the evaluation value for the service route of the vehicle 50, according to the time at which the user U1 desires to board the vehicle 50 or the time slot in which the user U1 desires to travel using the vehicle 50.

In this modification, when the evaluation value for the travel route in a certain travel time slot is equal to or less than a threshold, the controller 21 further obtains an evaluation value for the travel route in a time slot included in a different segment from the segment for the travel time slot, based on the travel route evaluation results 60 corresponding to the different segment from the segment of the travel time slot. For example, if the threshold is 4 [points] and the evaluation value obtained for the morning segment is 3.8 [points], meaning that the obtained evaluation value is equal to or less than the threshold, the controller 21 thus obtains an evaluation value for the service route based on the travel route evaluation results 60 corresponding to the afternoon segment.

In Step S106, the controller 21 provides, to the reserving party as the user U1, an evaluation value for the travel route in a time slot included in the different segment, in place of the evaluation value for the travel route in the travel time slot or together with the evaluation value for the travel route in the travel time slot. Specifically, the controller 21 may notify the user U1 of the evaluation value obtained for the afternoon segment, in place of the evaluation value obtained for the morning segment, or together with the evaluation value obtained for the morning segment.

According to this modification, the user U1 can learn of the evaluation value for the travel route corresponding to a different time slot from the time slot in which the user U1 desires to travel using the vehicle 50. Further, the user U1 can compare the evaluation value for the travel route corresponding to the time slot in which the user U1 desires to travel using the vehicle 50 with the evaluation value for the travel route corresponding to a different time slot from the time slot in which the user U1 desires to travel using the vehicle 50.

In the aforementioned modification, when the evaluation value obtained for the afternoon segment is still equal to or less than the threshold, or when the evaluation value obtained for the afternoon segment is equal to or less than the evaluation value obtained for the morning section, the controller 21 of the information providing apparatus 20 may notify the user U1 of the evaluation value obtained for the morning segment, without notifying the user U1 of the evaluation value obtained for the afternoon segment.

In the disclosed embodiment, the evaluation for each of the service route is an evaluation made based on at least one of an evaluation factor for the vehicle 50 traveling on a certain service route and an evaluation factor for the service route. Examples of the evaluation factors for the vehicle 50 include the manners of passengers of the vehicle 50; the proportion by gender of the passengers; the proportion by age of the passengers; and the level of congestion of the vehicle 50. Examples of the evaluation factors for a service route include the length of the service route; the time needed to travel along the service route; and the usage fee for the service route.

An exemplary method for evaluating the service routes in the disclosed embodiment includes evaluating each of the service routes based on the result of evaluation made by an evaluator, who is a user U2, who was on board the vehicle 50 on a certain service route, for one or more other users who were also on board the vehicle 50. The evaluation for the other users includes, for example, evaluation of the manners of passengers on the vehicle 50. The evaluation of the manners of the passengers is made, for example, by scoring, by the user U2, the behavior of at least one of the other users on board together with the user U2. The user U2 subtracts a predetermined score when the at least one of the other users is ill-mannered, and adds a predetermined score when at least one of the other users is well-mannered. Alternatively, the user U2 may subtract or add the score in steps, depending on the degree or type of the ill-manners or the degree or type of the well-manners. Examples of ill-mannered users include a user who is making cellular phone calls, a user who is speaking loudly, and a user who is walking while the vehicle is traveling. Examples of well-mannered users include a user who is holding his/her baggage in front; a user who is giving up a seat; and a user who is sitting properly in their seat so that other users have a chance to sit. The behavior of the other users may be determined by the controller 21, rather than by the user U2, based on, for example, the behaviors of the other users detected by a known sensor or the like installed in advance in the vehicle 50. In this way, the controller 21 of the information providing apparatus 20 includes, in the service route evaluation results 60, an evaluation made by the evaluator, who is the user U2 who was on board the vehicle 50, for one or more of other users who were also on board the vehicle 50.

Another exemplary method for evaluating the service routes in the disclosed embodiment includes evaluating each of the service routes based on the level of congestion of the vehicle 50. Specifically, the controller 21 of the information providing apparatus 20 determines the level of congestion of the vehicle 50 on a certain service route. The controller 21 subtracts a predetermined score when the level of congestion is equal to or more than a predetermined threshold. The controller 21 adds a predetermined score when the level of congestion is less than a predetermined threshold. Alternatively, the controller 21 may subtract the number of points stepwise as the level of congestion increases, or may add the number of points stepwise as the level of congestion decreases. The level of congestion may be evaluated by, for example, the evaluator, who is the user U2 who was on board the vehicle 50, rather than by the controller 21. In this way, the controller 21 includes the evaluation for the level of congestion of the vehicle 50 in the service route evaluation results 60.

Another exemplary method for evaluating the service routes in the disclosed embodiment includes evaluating each of the service routes based on the length of the route. Specifically, the controller 21 of the information providing apparatus 20 calculates the length of a certain service route. The controller 21 subtracts a predetermined score when the calculated length is equal to or more than a predetermined threshold. The controller 21 adds a predetermined score when the calculated length is less than a predetermined threshold. Alternatively, the controller 21 may subtract the score in steps as the length increases, or may add the score in steps as the length decreases. Instead of being calculated by the controller 21, the length of the service route may be stored in advance in the memory 22, for example, for each service route. In this way, the controller 21 includes the evaluation for the length of the service route in the service route evaluation results 60.

Another exemplary method for evaluating the service routes in the disclosed embodiment includes evaluating each of the service routes based on the time needed to travel along the service route. Specifically, the controller 21 of the information providing apparatus 20 calculates the time needed to travel along a certain service route. The controller 21 subtracts a predetermined score when the calculated time is equal to or longer than a predetermined threshold. The controller 21 adds a predetermined score when the calculated time is shorter than the predetermined threshold. Alternatively, the controller 21 may subtract the score in steps as the time becomes longer, or may add the score in steps as the time becomes shorter. Instead of being calculated by the controller 21, the time needed to travel along each of the service routes may be stored in the memory 22 in advance, for example, for each service route. In this way, the controller 21 includes the evaluation for the time needed to travel along each of the service route, in the travel route evaluation results 60.

Another exemplary method for evaluating the service routes in the disclosed embodiment includes evaluating each of the service routes based on the usage fee of the vehicle 50 on each of the service routes. Specifically, the controller 21 of the information providing apparatus 20 calculates a usage fee of a certain service route. The controller 21 subtracts a predetermined score when the calculated usage fee is equal to or more than a predetermined threshold. The controller 21 adds a predetermined score when the calculated usage fee is less than a predetermined threshold. Alternatively, the controller 21 may subtract the score in steps as the use fee increases, or may add the score in steps as the usage fee decreases. Instead of being calculated by the controller 21, the usage fee of the vehicle 50 in the service route may be stored in advance in the memory 22 for each service route, for example. In this way, the controller 21 includes the evaluation of the usage fee of the vehicle 50, in the service route in the service route evaluation results 60.

Another exemplary method for evaluating the service routes in the disclosed embodiment includes evaluating each of the service routes based on the proportion by gender of the passengers of the vehicle 50. Specifically, the controller 21 of the information providing apparatus 20 determines the proportion by gender of the passengers of the vehicle 50 on a certain service route. When the proportion of the passengers having the same gender as the user U1 is higher than the proportion of the passengers having the different gender, the controller 21 adds a predetermined number of points. The proportion by gender may be determined by, for example, an evaluator as the user U2 on board the vehicle 50, rather than by the controller 21. In this way, the controller 21 includes an evaluation for the proportion by gender of the passengers of the vehicle 50, in the service route evaluation results 60.

Another exemplary method for evaluating the service routes in the disclosed embodiment includes evaluating each of the service routes based on the proportion by age group of the passengers of the vehicle 50. Specifically, the controller 21 of the information providing apparatus 20 determines the proportion by age group of the passengers of the vehicle 50 on a certain service route. The controller 21 subtracts a predetermined score when the proportion of passengers whose age group is different from the age group of the user U1 is higher than the proportion of the passengers whose age group is the same as the age group of the user U1. The proportion of passengers by age group may be determined by, for example, an evaluator, who is the user U2 who is on board the vehicle 50, rather than by the controller 21. In this way, the controller 21 includes an evaluation for the proportion by age group of passengers of the vehicle 50, in the service route evaluation results 60.

In this way, the evaluation value for a certain travel route is uniquely identified for each combination of a first region that includes a departure point and a second region that includes an arrival point of each of the service routes. When the evaluation value for a certain travel route is equal to or less than a threshold, the controller 21 of the information providing apparatus 20 may obtain two evaluation values, based on the service route evaluation results 60; one of the evaluation values may be identified based on a combination of a departure region and an arrival region, the departure region being a region that includes the departure point of the travel route, the arrival region being a different region from the region that includes the arrival point of the travel route, and the other one of the evaluation values may be identified based on a combination of a departure region and an arrival region, the departure region being said different region, the arrival region being a region that includes the arrival point of the travel route. The controller 21 may provide the obtained two evaluation values to the user U1.

That is, as a modification of the disclosed embodiment, when the evaluation value for a travel route is equal to or less than a threshold, the controller 21 of the information providing apparatus 20 may obtain, based on the service route evaluation results 60, an evaluation value for a first route and an evaluation value for a second route. The first route is for traveling using the vehicle 50 from the first point P1 to a third point P3, the third point P3 being included in a different region from the region RA including the first point P1 and the region RI including the second point P2. The second route is for traveling, using the vehicle 50, from the third point P3 to the second point P2. In this modification, the third point P3 is included in the region RC as illustrated in FIG. 4. However, without being limited thereto, the third point P3 may be included in any region as long as the region is different from the region RA that includes the first point P1 and the region RI that includes the second point P2.

In Step S105 of FIG. 6, the controller 21 of the information providing apparatus 20 refers to the service route evaluation results 60 of FIG. 5, and obtains 2.4 [points], which is an evaluation value identified for the combination of the region RA as the departure region and the region RC as the arrival region, and 4.2 [points], which is an evaluation value identified for the combination of the region RC as the departure region and the region RI as the arrival region.

The controller 21 of the information providing apparatus 20 performs the same process from Step S106 to Step S108 of FIG. 6, and provides the evaluation value of the first route and the evaluation value for the second route, to the reserving party. Specifically, the controller 21 notifies the user U1 as the reserving party of 2.4 [points] as the evaluation value of the first route and 4.2 [points] as the evaluation value of the second route.

According to this modification, when the evaluation value for a certain travel route is equal to or less than a threshold, the controller 21 of the information providing apparatus 20 provides, to the user U1, an evaluation value for the first travel route to travel using the vehicle 50 from the first point P1 to the third point P3 and an evaluation value for the second route to travel using the vehicle 50 from the third point P3 to the second point P2. In this way, the controller 21 can provide an evaluation value for a new travel route to be traveled from the first point P1 through the third point P3 to the second point P2 so as to substantially bypass a travel route whose evaluation value that is equal to or less than a threshold.

As a modification of the disclosed embodiment, the controller 21 of the information providing apparatus 20 may obtain an average value of the evaluation value of the first route and the evaluation value of the second route, and provide the obtained average value as the evaluation value for the first route and the second route, to the reserving party. Specifically, the controller 21 obtains an average value of 2.4 [points] and 4.2 [points]. The average value is 3.3 [points]. The controller 21 performs the same process from Step S106 to Step S108 in FIG. 6, and Provides 3.3 [points] as the obtained average value to the reserving party.

According to this modification, the user U1 can easily compare the evaluation value for a new travel route to be traveled by the vehicle 50 from the first point P1 to the second point P2 via the third point P3 substantially bypassing the travel route whose evaluation value is equal to or less than the threshold, with the evaluation value for the travel route whose evaluation value is equal to or less than the threshold.

The present disclosure is not limited to the embodiments described above. For example, the plurality of blocks in the block diagrams may be combined, or each of the blocks may be divided. The plurality of steps in the flowchart may be executed in parallel or in a different order according to the processing capability of the apparatus for executing each step, instead of being executed in chronological order as illustrated. The present disclosure may be changed without departing from the gist of the present disclosure.

1. An information providing apparatus comprising a controller configured to:
acquire first point information and second point information, the first point information indicating a point at which a reserving party, who is a user who is to reserve a vehicle to be operated within a geographical range that includes a plurality of regions, desires to board the vehicle, the second point information indicating a point at which the reserving party desires to alight the vehicle;
obtain, based on a service route evaluation result obtained as a result of having evaluated a service route of the vehicle per combination of a first region and a second region among the plurality of regions, the first region including a departure point of the service route, the second region including an arrival point of the service route, an evaluation value for a travel route along which the reserving party is to travel using the vehicle from the first point indicated by the first point information to the second point indicated by the second point information; and
provide the obtained evaluation value to the reserving party.

2. The information providing apparatus according to claim 1, wherein:
the service route evaluation result includes a result obtained as a result of having evaluated the service route for each of a plurality of classifications for operating days of the vehicle; and
the controller is configured to
identify, among the plurality of classifications, a classification for a certain travel day, and obtain, based on the service route evaluation result corresponding to the identified classification, an evaluation value for the travel route on the travel day, as the evaluation value for the travel route.

3. The information providing apparatus according to claim 2,
wherein the plurality of classifications include a weekday classification and a weekend classification.

4. The information providing apparatus according to claim 2, wherein, when the evaluation value for the travel route on the travel day is equal to or less than a threshold, the controller is configured to obtain, based on a service route evaluation result corresponding to a different classification from the classification for the travel day, an evaluation value for the travel route on a day included in the different classification, and provide, to the reserving party, the evaluation value for the travel route on the day included in the different classification, in place of the evaluation value for the travel route on the travel day or together with the evaluation value for the travel route on the travel day.

5. The information providing apparatus according to claim 1, wherein:
the service route evaluation result includes a result of having evaluated the service route for each of a plurality of segments for an operating time period of the vehicle; and
the controller is configured to:
identify, among the plurality of segments, a segment for a certain travel time slot, and, based on the service route evaluation result corresponding to the identified segment, obtain an evaluation result for the travel route in the travel time slot, as the evaluation value for the travel route.

6. The information providing apparatus according to claim 5, wherein the plurality of segments include a morning segment and an afternoon segment.

7. The information providing apparatus according to claim 5, wherein, when the evaluation value for the travel route in the travel time slot is equal to or less than a threshold, the controller is configured to obtain, based on the service route evaluation result corresponding to a different segment from the segment in the travel time slot, an evaluation value for the travel route in a time slot included in the different segment, and provide, to the reserving party, an evaluation value for the travel route in the time slot included in the different segment, in place of the evaluation value for the travel route in the travel time slot, or together with the evaluation value for the travel route in the travel time slot.

8. The information providing apparatus according to claim 1, wherein the controller is configured to include, in the service route evaluation result, an evaluation made by an evaluator, who is a user who was on board the vehicle, of another user who was also on board the vehicle.

9. The information providing apparatus according to claim 1, wherein the controller is configured to include, in the service route evaluation result, an evaluation of a degree of congestion in the vehicle.

10. The information providing apparatus according to claim 1, wherein the controller is configured to include, in the service route evaluation result, evaluation of a length of the service route.

11. The information providing apparatus according to claim 1, wherein the controller is configured to include, in the service route evaluation result, evaluation of a time needed to travel along the service route.

12. The information providing apparatus according to claim 1, wherein the controller is configured to include, in the service route evaluation result, evaluation of a usage fee for the vehicle on the service route.

13. The information providing apparatus according to claim 1, wherein the controller is configured to include, in the service route evaluation result, evaluation of a proportion by gender of passengers on the vehicle.

14. The information providing apparatus according to claim 1, wherein the controller is configured to include, in the service route evaluation result, evaluation of a proportion by age of passengers on the vehicle.

15. The information providing apparatus according to claim 1, wherein, when the evaluation value for the travel route is equal to or less than a threshold, the controller is configured to obtain, based on the service route evaluation result, an evaluation value for a first route and an evaluation value for a second route, the first route being a route along which the user is to travel using the vehicle from the first point to a third point included in a different region from a region that includes the first point and a region that includes the second point, the second route being a route along which the user is to travel using the vehicle from the third point to the second point, and provide the evaluation value for the first route and the evaluation value for the second route to the reserving party.

16. The information providing apparatus according to claim 15, wherein the controller is configured to obtain an average value of the evaluation value for the first route and the evaluation value for the second route, and provide, to the reserving party, the obtained average value as the evaluation value for the first route and the second route.

17. An information providing system comprising:
the information providing apparatus of claim 1; and
a terminal apparatus of the reserving party, the terminal apparatus configured to receive a notification of the evaluation value from the information providing apparatus.

18. A non-transitory computer-readable medium storing a program configured to cause a computer to execute operations, the operations comprising:
acquiring first point information and second point information, the first point information indicating a point at which a reserving party, who is a user who is to reserve a vehicle to be operated within a geographical range that includes a plurality of regions, desires to board the vehicle, the second point information indicating a point at which the reserving party desires to alight the vehicle;
obtaining, based on a service route evaluation result obtained as a result of having evaluated a service route of the vehicle per combination of a first region and a second region among the plurality of regions, the first region including a departure point of the service route, the second region including an arrival point of the service route, an evaluation value for a travel route along which the reserving party is to travel using the vehicle from the first point indicated by the first point information to the second point indicated by the second point information; and
transmitting the obtained evaluation value to a terminal apparatus of the reserving party.

19. An information providing method comprising:
acquiring, by an information providing apparatus, first point information and second point information, the first point information indicating the point at which a reserving party, who is a user who is to reserve a vehicle to be operated within a geographical range that includes a plurality of regions, desires to board the vehicle, the second point information indicating the point at which the reserving party desires to alight the vehicle;
obtaining, by the information providing apparatus, based on a service route evaluation result obtained as a result of having evaluated a service route of the vehicle per combination of a first region and a second region among the plurality of regions, the first region including a departure point of the service route, the second region including an arrival point of the service route, an evaluation value for a travel route along which the reserving party is to travel using the vehicle from the first point indicated by the first point information to the second point indicated by the second point information; and
transmitting, by the information providing apparatus, the obtained evaluation value to a terminal apparatus of the reserving party.

20. The information providing apparatus according to claim 19, further comprising including, in the service route evaluation result, by the information providing apparatus, an evaluation made by an evaluator, who is a user who was on board the vehicle, of another user who was also on board the vehicle.
